(19) United States
(12) Patent Application Publication
(10) Pub. No.: US 2008/0260046 A1
(43) Pub. Date: Oct. 23, 2008

(54) Coding/Decoding Method and Apparatus For Improviding Video Error Concealment

(75) Inventors: Daqing Zhang, Shanghai (CN); Jin Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,955

(22) PCT Filed: Sep. 15, 2006
(86) PCT No.: PCT/IB06/53300

§ 371 Date: Mar. 25, 2008

(30) Foreign Application Priority Data
Sep. 26, 2005 (CN) 200510105033.3

(51) Int. Cl. H04N 7/26

(52) U.S. Cl. 375/240.27; 375/E07.189

(57) ABSTRACT

A coding/decoding method and an apparatus for improving video error concealment are provided, wherein the coding method comprises obtaining the relevant information of a mostly matching area for an area, wherein both the mostly matching area and the area are located in the same picture; and coding the relevant information of the mostly matching area into a coded video stream comprising the area. With the error concealment of the present invention, only several bits are required to be added when coding, whereby the whole picture appears more natural during decoding and error concealment, and the picture quality is also significantly enhanced.

### FIELD OF THE INVENTION

The present invention relates to a video coding/decoding method and apparatus, more particularly to a coding/decoding method and apparatus for improving video error concealment.

### BACKGROUND OF THE INVENTION

In the applications of digital TV (SDTV/HDTV) and multimedia, in order to cater to different requirements, many video compression standards have emerged, such as Motion Picture Experts Group (MPEG), H.263, and Quicktime. The main object of these standards is to make the compressed video stream have low bit rate and good quality. However, since the bit errors, either isolated or in burst, in the coded video stream, i.e., bit-stream errors, frequently results in synchronization failure of the decoder, which is unable to function until the next resynchronization point is reached, whereby the quality of the picture is degraded.

One possible way to avoid the degradation of the picture quality is that, in the decoding apparatus, the parts with errors are masked on the decoded picture by using error concealment technique. For example, PCT Patent Publication No. WO 2004/064397 has disclosed an error concealment method for a decoded picture, which comprises building an intra-prediction mode for the Macroblock (MB) with pixel data errors relative to the adjacent blocks during the decoding process, such that the predicted pixel data is derived for correcting the error.

However, the effects of error concealment techniques for the decoding apparatus are limited. For example, for the above PCT patent, since it only predicts one or more intra-prediction modes relative to the adjacent blocks during the decoding process, if the difference between the MB with the pixel data error and the adjacent MBs is relatively significant, the quality of the picture will not be improved by the error concealment effects of this method.

Another consideration for the error concealment is that the importance of different kinds of coded MB is different. For example, in MPEG-2, the coded frame can be classified into three types, i.e. I frame, P frame, and B frame. But, when the Temporal Redundancy of the picture is relatively low, the MB on I frame, P frame, or B frame all need to be intra-coded. The intra-coding process is mainly used to prevent the floating of the reference picture caused by bit error from influencing the current frame, and when the intra-coded MB is lost, it is quite difficult for the decoder to conceal it. Thus, the intra-coded MB is generally more important than the inter-coded MB. In addition, when the video data is transmitted via an error-prone channel, intra-coded MB can be used to enhance bit error robustness of the bit stream by updating some areas of the picture content. Therefore, when the intra-coded MBs are lost or damaged, it is more desirable to better conceal the intra-coded MBs.

No matter what type of MB is, the above methods conceal the errors through different interpolation or copying schemes based on the adjacent MBs. All these methods are based on one assumption, that is, the closer MBs are, the more similar their contents are. When this consumption is false, the error concealment cannot achieve the desired effects. Therefore, a coding/decoding method and an apparatus for improving video error concealment are desirable, for providing more preferable error concealment during the decoding process.

### OBJECT AND SUMMARY OF THE INVENTION

The present invention provides a coding/decoding method and an apparatus for improving video error concealment, whereby the replacement MB is more similar to the original one, the whole picture appears more natural, and the quality of the picture is significantly improved.

According to an embodiment of the present invention, a coding method for improving video error concealment is provided, which comprises obtaining the relevant information of a mostly matching area for an area, wherein the mostly matching area and the area are located in the same picture; and coding the relevant information of the mostly matching area into a coded video stream comprising the area.

According to another embodiment of the present invention, a decoding method for improving video error concealment is provided, which comprises obtaining the matching information of a damaged MB in a picture, wherein the matching information indicates at least one matching area in the picture; and replacing the damaged MB with at least one matching area according to the matching information.

According to still another embodiment of the present invention, a coding apparatus for improving video error concealment is provided, which comprises an obtaining apparatus, for obtaining the relevant information of a mostly matching area for an area, wherein the mostly matching area and the area are located in the same picture; and a writing apparatus, for coding the relevant information of the mostly matching area into a coded video stream comprising the area.

According to yet another embodiment of the present invention, a decoding apparatus for improving video error concealment is provided, which comprises an obtaining apparatus, for obtaining the matching information of a damaged MB in a picture, wherein the matching information indicates at least one matching area in the picture; and a replacing apparatus, for replacing the damaged MB with the at least one matching area according to the matching information.

According to the embodiment of the present invention, the mostly matching area is obtained through searching and matching in a specific range of a picture, and after replacing the lost or damaged MB with the mostly matching replacement MB, the recovered MB is more similar to the original one and the quality of the picture is significantly enhanced. Moreover, only several bits need to be added into the bit stream when coding, whereby the increase in coding burden is negligible.

The other objects and achievements of the present invention will become apparent through the description of the present invention and the claims, with reference to the accompanying drawings, and the present invention will be generally understood.

### BRIEF DESCRIPTION OF THE DRAWINGS

FIG. 1 is a flow chart of a coding method for error concealment according to an embodiment of the present invention;

FIGS. 2a-2d are mode diagrams of the different classification of one MB according to an embodiment of the present invention;

FIG. 3 is a flow chart of a coding method for error concealment according to another embodiment of the present invention;

FIG. 4 is a schematic view of the syntactic structure for an MPEG-coded picture;

FIG. 5 is a schematic view of the syntactic structure for an MPEG-coded picture according to an embodiment of the present invention;

FIG. 6 is a schematic view of coding the matching vector information or the information that there is no matching vector into a slice header segment according to an embodiment of the present invention;

FIG. 7 is a flow chart of a decoding method for error concealment according to an embodiment of the present invention;

FIG. 8 is a schematic view of the structure of a coding apparatus according to an embodiment of the present invention; and

FIG. 9 is a schematic view of the structure of a decoding apparatus according to an embodiment of the present invention.

In all of the above accompanying drawings, the same referential numerals are used to indicate the same, similar, or corresponding characteristics or functions.

### DETAILED DESCRIPTION OF THE INVENTION

An improved error concealment scheme is provided in an embodiment of the present invention. When coding, the MB to be coded is divided into one or more sub-units through a specific mode; a mostly matching area for each sub-unit is searched for under this mode; and the information of the mostly matching area is coded into a bit stream. When decoding, if the MB is lost or damaged, the mostly matching area of the lost or damaged MB is used to replace the MB, such that the replaced sub-unit is more similar to the original one, thus the whole picture appears more natural, and meanwhile the quality of the picture is also significantly improved.

Since the intra-coded MB is more important than other MBs, the coding for improving error concealment of the present invention can be carried out to the intra-coded MBs on the I frame, P frame, and B frame in the bit stream, such that the coding efficiency can be enhanced optimally, thereby achieving more desirable concealing effects. However, it is not intended to limit the present invention to the intra-coded MB. The present invention can be applied to the MBs for forward coding, bidirectional coding, or other coding methods, by those skilled in the art after they have appreciated the contents of this specification.

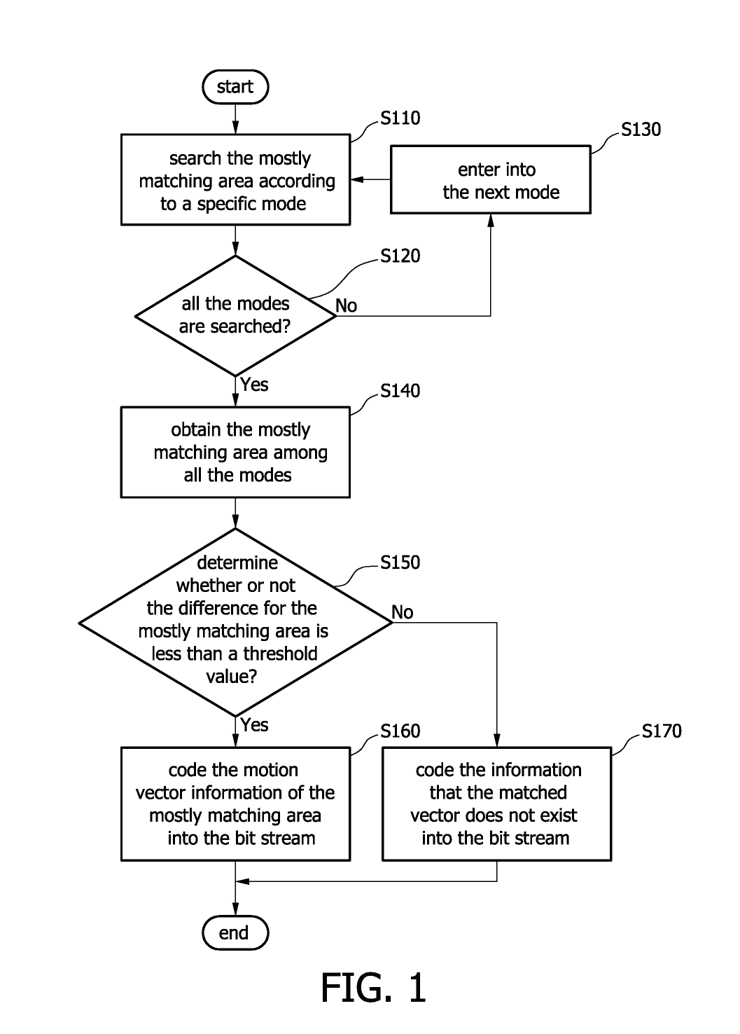

FIG. 1 is a flow chart of a coding method for improving error concealment according to an embodiment of the present invention. In this embodiment, the mostly matching area is searched for through all the predetermined modes.

First, in step S110, according to a predetermined mode, an area most matching the current MB to be coded in the current picture is searched for under this searching mode. The so-called mode is a division manner of the current MB to be coded. The MB to be coded is divided into one or more different sub-units under a specific division mode. As for each sub-unit, the mostly matching area is searched for in the current picture. According to an embodiment of the present invention, the searching process can be carried out as follows: first, defining a searching window with the same size as that of the sub-unit to be searched for; and then, traversing the current picture with the searching window, to find out the area with the smallest difference with the current sub-unit.

Certainly, it is understood by those skilled in the art that, the searching window can also be used to traverse an area with a specific size within the current picture, which can be set by the user, for example, a rectangle-shaped area having a specific size with the sub-unit to be searched as a centre, thereby the calculations for coding can be appropriately reduced.

Due to the different complexity of the pictures, the desirable effects may not be achieved for all of the MBs, if only one division mode is used. Therefore, according to an embodiment of the present invention, various modes can be combined for searching, such that the obtained mostly matching area is more similar to the original picture. For example, many division modes can be predetermined. When the searching process with one predetermined mode is finished, in step S120, determine whether the searching processes with all of the predetermined modes have been finished. If not, in step S130, enter into and search the predetermined mode not having been searched. This is repeated until all of the predetermined modes have been searched.

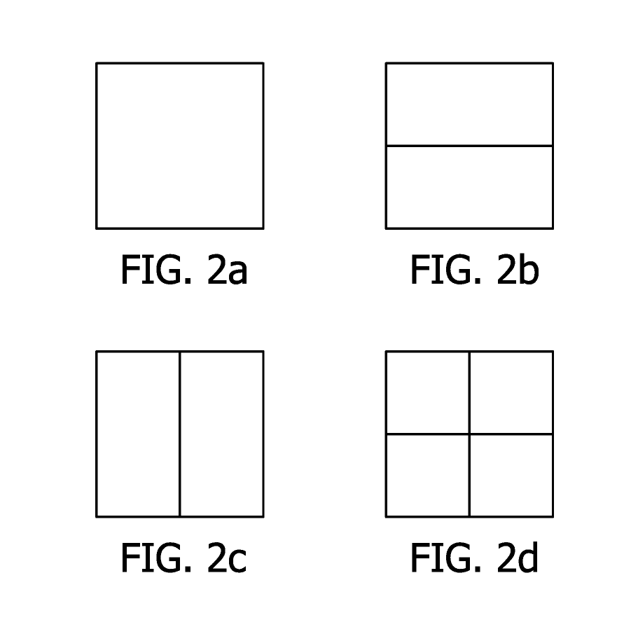

FIGS. 2a-2d show four possible examples of the division modes of one MB. In the mode shown in FIG. 2a, the MB to be coded is considered as one sub-unit and is searched; whereas in the mode shown in FIGS. 2b and 2c, the MB to be coded has been respectively divided into two sub-units horizontally and vertically; and in the mode as shown in FIG. 2d, the MB to be coded is divided into four sub-units on average, with each sub-unit being searched separately.

As for the present invention, there are many searching modes, which are not limited to the above-listed four modes. For example, the MB to be coded can be divided more finely, wherein the division can be carried out uniformly or non-uniformly, or multiple MBs can be considered as a whole to be searched. According to an embodiment of the present invention, it can be searched through the four modes as shown in FIGS. 2a-2d, and the sequence of each mode can be fixed in advance or random.

In step S140, compare the results obtained from all the division modes and select an area with the smallest difference with the MB to be coded as the mostly matching area for the MB to be coded. To compare the results of the individual modes, the difference between each sub-unit and the mostly matching area is firstly obtained under each division mode. This difference can be represented in many forms, for example, according to an embodiment of the present invention, this difference can be represented as a sum of absolute difference (SAD), that is:

$$SAD = {\sum }_{x = 0}^{X} {\sum }_{y = 0}^{Y} \vert {B}_{ma} ( x , y ) - {B}_{rf} ( x , y ) \vert ;$$

wherein, x indicates the abscissa of the pixel in MB; X indicates the width of the area selected as a sub-unit in the MB; y indicates the ordinate of the pixel in MB; Y indicates the height of the area selected as a sub-unit in MB; Bₘₐ(x, y) indicates the luminance component value of the pixel with the coordinate of (x, y) in the MB to be coded; B_{rf}(x, y) indicates the luminance component value of the pixel with the coordinate of (x, y) in the searched matching MB. Note that as for the calculations of SAD, generally only Y luminance component is employed; certainly, if the calculation complexity is not considered, the additional two components, i.e., chroma information in the color information (U) and chromatism information in the color information (V), can also be used.

The difference also can be represented by the mean absolute difference (MAD), that is,

$$MAD = \sqrt{{\sum }_{x = 0}^{X} {\sum }_{y = 0}^{Y} {[ {B}_{ma} ( x , y ) - {B}_{rf} ( x , y ) ]}^{2} ;}$$

wherein, x indicates the abscissa of a pixel in the MB; X indicates the width of the area selected as a sub-unit in the MB; y indicates the ordinate of the pixel in the MB; Y indicates the height of the area selected as a sub-unit in the MB; Bₘₐ(x, y) indicates the luminance component value of the pixel with the coordinate of (x, y) in the MB to be coded; B_{rf}(x, y) indicates the luminance component value of the pixel with the coordinate of (x, y) in the searched matching MB. Note that similar to the calculations of SAD, as for the calculations of MAD, generally only the Y luminance component is employed, but without the additional two components, i.e., chroma information in the color information (U) and chromatism information in the color information (V).

After the difference between each sub-unit and the mostly matching area has been obtained, the difference value of the MB to be coded can be obtained by adding these differences (MAD) together. The difference values of the MB to be coded, calculated, and obtained under different division modes are compared. One or more mostly matching areas under the division mode with the smallest difference value is (are) the mostly matching area(s) of the MB to be coded. Due to the different modes, a group of mostly matching areas of the MB to be coded may be distributed in the whole picture to be coded.

Even if various modes are employed for the searching process, the obtained mostly matching area may also have significant differences with the original picture. In this case, the error concealment step cannot achieve the anticipated effects. If still being coded, many inefficient coding operations are added, resulting in a waste of resources. Therefore, the mostly matching areas obtained in step S140 can be filtered to improve coding efficiency.

In step S150, the difference between the mostly matching area and the original picture is compared with a predetermined threshold value, if the difference satisfies the condition of the threshold value, i.e., less than or equal to the threshold value, the information of the mostly matching area under this mode is coded into a coded video stream in step S160. If the difference exceeds the threshold value, the information indicating that there is no mostly matching area is coded into the coded video stream in step S170. Finally, the above coding process is finished.

According to an embodiment of the present invention, the threshold value for filtering the mostly matching areas of the MB to be coded can be an experience value obtained according to the actual conditions and experience. For example, the threshold value can be set to be 2×W×H, wherein W, H are the width and height of the used sub-unit. Otherwise, a value nearly twice of the MB can be used as the threshold value. For example, if the MB is 16×16, the threshold value can be a value of 512 or about 512. Certainly, there are many ways to obtain the threshold value, which thus will not be recited one by one herein.

According to an embodiment of the present invention, the information of the mostly matching area comprises the mode information and one or more motion vectors directed to the mostly matching area under this mode. The characteristic information of the sub-unit, such as one MB, the top half part of one MB, or an area of the top left quarter of one MB, can be obtained through the mode information. The position of the most preferred area can be obtained through the motion vector. The information of the mostly matching area also can be represented by many other ways, for example, by directly giving the width and height of the mostly matching area and the position of one top point, which will not be recited herein redundantly.

According to an embodiment of the present invention, the information indicating that there is no mostly matching area can be a sign of a specific position in the bit stream. For example, if the sign bit is 0, it indicates that there is no mostly matching area; if the sign bit is 1, it indicates that there is a mostly matching area.

A desirable effect can be achieved in the above embodiment, but in the case of considering the limited calculation capability of the coding terminal and the required higher coding speed, direct filtering for the threshold value can also be carried out, that is, each time after one predetermined mode has been searched, it will be compared with the threshold value, and as long as the condition of the threshold value is satisfied, the searching will not be carried out any more. Therefore, not all the predetermined modes need to be searched.

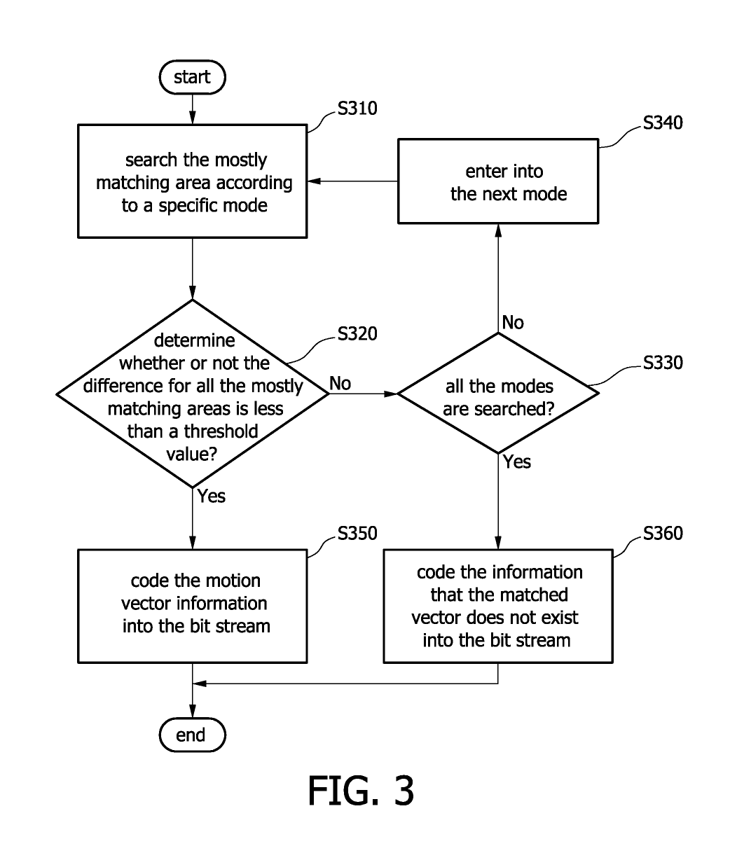

According to another embodiment of the present invention, FIG. 3 is a flow chart of a coding method for improving the error concealment. In this method, searching is performed with a specific mode to obtain the mostly matching areas for all sub-units of the MB to be coded under this mode. Then, under this mode, whether the differences of the mostly matching areas for all sub-units are respectively less than or equal to the threshold value is determined. If so, the information of the mostly matching area is coded into a coded video stream; otherwise, searching is performed with other modes, until the mostly matching area satisfying the threshold value condition has been found, or until all of the predetermined modes have been searched. Therefore, as long as the threshold value condition is satisfied, the coding process can be carried out, which will greatly reduce calculations, and accelerate coding speed.

According to another embodiment of the present invention, whether the differences of the mostly matching areas for a part of the sub-units (e.g., more than 75%) are respectively less than or equal to the threshold value, instead of determining whether the differences of the mostly matching areas for all sub-units are respectively less than or equal to the threshold value, can also be determined.

Steps S310, S330, S340, S350, S360, and S370 in this embodiment are similar to steps S110, S120, S130, S160, S170, and S180 in the embodiment as shown in FIG. 1, which will not be described herein redundantly.

In step S320, the difference between each sub-unit of the MB to be coded under this mode and its mostly matching area is compared with the predetermined threshold value. If the differences of all sub-units are less than or equal to the threshold value, it turns to the subsequent step S350. If the threshold value condition is not satisfied, it turns to step S330, wherein searching is performed with other predetermined modes. If all of the predetermined modes have been searched, it turns to step S360, wherein the information that there is no matching area is coded into a coded video stream.

In this embodiment, the threshold value in step S320 is relevant to the size of the sub-unit. For example, for the searching mode shown in FIG. 2a, if the size of the MB is 16×16, and the size of sub-unit is also 16×16, the threshold value is still 512. In the searching mode as shown in FIG. 2b, if the size of the sub-unit is 16×8, and there are 128 pixels, the threshold value can be obtained as 512/2=256. Similarly, in the searching mode as shown in FIG. 2c, the threshold value also can be 512/2=256, and in the searching mode as shown in FIG. 2d, the threshold value can be 512/4=128.

How to code the information of the mostly matching area into a video stream is further illustrated in detail below. More particularly, taking the MPEG coding as an example, the specific coding method will be illustrated with the precondition that the scheme of the present invention is only applied to the intra-coded MB.

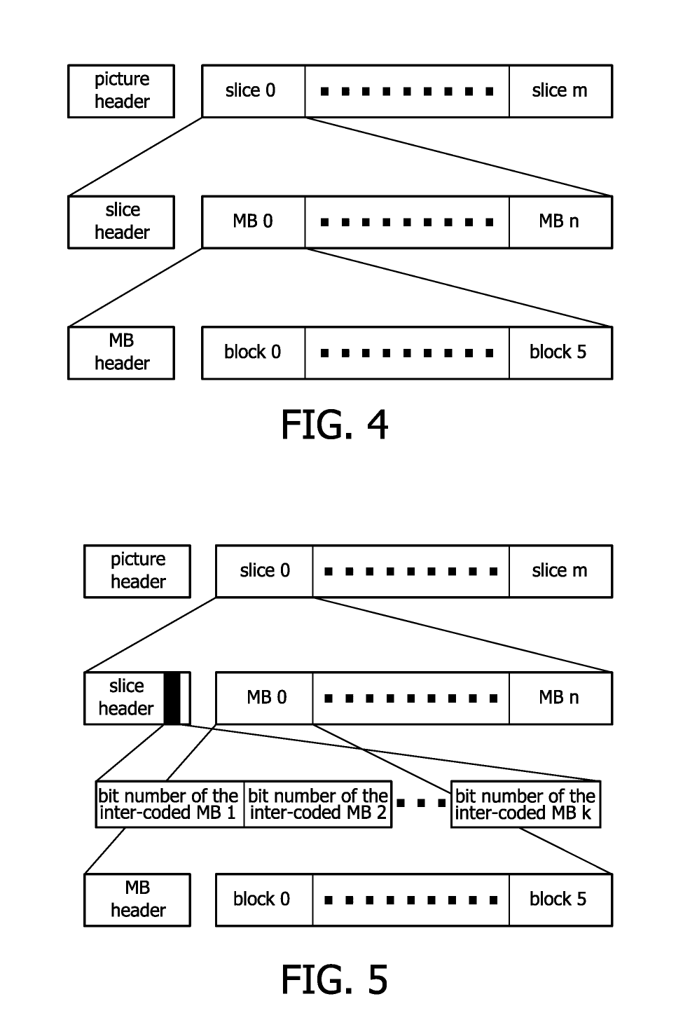

FIG. 4 is a schematic view of a syntactic structure of the common MPEG-coded picture. As shown in FIG. 4, besides the complete video information blocks, each picture further comprises: a picture header segment, a slice header segment, and an MB header segment. Additionally, each MB header of the MB comprises the information indicating whether the MB is intra-coded or inter-coded (not shown).

As shown in FIG. 5, according to an embodiment of the present invention, the matching information indicating the intra-coded MB within a slice is coded into the slice header of each slice. In the MPEG standard, besides the necessary information required in the standard, a retained field is further included in the slice header segment, for coding other information as desired. In this embodiment, such a retained field is utilized to indicate whether there is a mostly matching area and the most preferred matching vector information for each intra-coded MB in the slice.

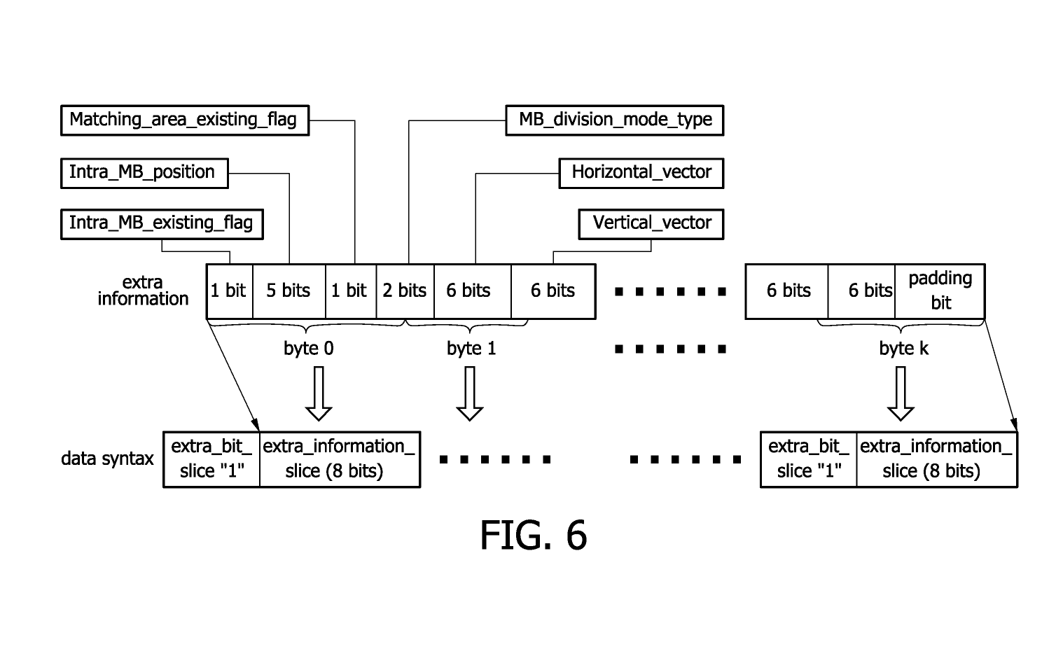

FIG. 6 is a schematic view for coding the information of the matching area of the intra-coded MB, matching vector information, and the like into the slice header segment. All the relevant information coded into the slice header segment constitutes the intra-coded MB matching information, which comprises a sequence of bits with a variable length, and particularly comprises sign (1): whether the intra-coded MB exists or not; if affirmative, the position of the intra-coded MB is indicated; sign (2): whether an area that matches the intra-coded MB exists or not; if affirmative, the division mode information of the intra-coded MB and the motion vector directed to the mostly matching area is coded into the bit stream.

The first bit of sign (1), i.e., Intra_MB_existing_flag (with reference to FIG. 1) is used to indicate whether the sign intra-coded MB exists or not.

TABLE 1
Code table of the signs for indicating whether the
intra-coded MB exists or not

| Code | Intra_MB_existing_flag |
|---|---|
| 0 | Does not exist |
| 1 | Exists |

If the intra-coded MB exists, i.e., the Intra_MB_existing_flag is 1, the following adjacent 5 bits are used to indicate the position of the intra-coded MB, i.e., Intra_MB_position (with reference to Table 2); if it does not exist, the Intra_MB_existing_flag is 0.

TABLE 2
Code table of the intra-coded MB position information
in the current slice, when Intra_MB_existing_flag is 1

| 5 bit Code | Intra_MB_position |
|---|---|
| 00001 | 1st MB after the slice header |
| 00010 | 2nd MB after the slice header |
| 00011 | 3rd MB after the slice header |
| 00100 | 4th MB after the slice header |
| . . . | . . . |
| 10000 | 16th MB after the slice header |
| . . . | . . . |
| 11111 | 31st MB after the slice header |

The first bit of sign (2) is also a bit of sign, i.e., Matching_area_existing_flag (shown in Table 3), for indicating whether there is an area matching the intra-coded MB.

TABLE 3
Code table of the sign for indicating whether there is a
matching area for the intra-coded MB in the current picture

| Code | Matching_area_existing_flag |
|---|---|
| 0 | Does Not Exist |
| 1 | Exists |

If the area exists, i.e., the Matching_area_existing_flag is 1, the following code bits are used to indicate the mode for dividing the intra-coded MB, i.e., the MB_division_mode_type, which is also the characteristic information of the sub-unit, referring to Table 4.

TABLE 4
Code Table of the MB division mode, when the
Matching_area_existing_flag is 1

| Code | MB_division_mode_type |
|---|---|
| 00 | Mode a |
| 01 | Mode b |
| 10 | Mode c |
| 11 | Mode d |

As for the four types of modes shown in FIGS. 2a-2d, the 2 bits of binary code can be used to indicate all the four types of modes, e.g., mode a, mode b, mode c, and mode d. If more than four types of modes are utilized, the number of bits of the MB_division_mode_type will be increased correspondingly.

At the end of sign (2) is the vector directed to the mostly matching area for each sub-unit of the intra-coded MB generated by this mode, which comprises horizontal vector, i.e., horizontal_vector, and vertical vector, i.e., vertical_vector (shown in Table 5).

TABLE 5
Code Table of the motion vector matching
each sub-unit of the intra-coded MB

| 6-bit code | horizontal_vector | 6-bit code | vertical_vector |
|---|---|---|---|
| 000001 | 1 | 000001 | 1 |
| 000010 | 2 | 000010 | 2 |
| 000011 | 3 | 000011 | 3 |
| 000100 | 4 | 000100 | 4 |
| . . . | . . . | . . . | . . . |
| 100000 | 32 | 100000 | 32 |
| . . . | . . . | . . . | . . . |
| 111111 | 63 | 111111 | 63 |

According to the syntax of the MPEG slice header as shown in Table 6, each 8 bits of matching information of the intra-coded MB constitute one byte, acting as an extra information segment, i.e., extra_information_slice, and remainder bits at the end numbering less than 8 are compensated with padding bits (such as, 1) to form a complete byte. An extra information segment is inserted after each extra bit segment of “1”, i.e., after the extra_bit_slice. For example, one intra-coded MB is divided into 4 sub-units, including 1 (the existence of the intra-coded MB)+5 (the position of the intra-coded MB)+1 (the existence of the matching area)+2 (totally four types of predetermined modes)+12 (horizontal and vertical vectors)×4 (number of the sub-units)=57 bits, with 7 padding bits (such as, 1) for compensation so as to form 64 bits, totally 8 bytes. Then, it is coded into the slice header according to the syntax of MPEG. The content related to the extra_information_slice and the relevant syntax can be referred to the relevant MPEG standards.

TABLE 6
Syntax of the slice header

| slice( ) | bits | Mnemonic |
|---|---|---|
| slice_start_code | 32 | Bslbf |
| If (vertical_size>2800) | | |
| slice_vertical_position_extension | 3 | Uimsbf |
| if (<sequence_scalable_extension( ) is present in | | |
| the bitstream>) | | |
| If (scalable_mode ==”data partitioning” | | |
| priority_breakpoint | 7 | Uimsbf |
| Quantiser_scale_code | 5 | Uimsbf |
| If ( nextbits( )==’1’) { | | |
| intra_slice_flag | 1 | Bslbf |
| Intra_slice | 1 | Uimsbf |
| reserved_bits | 7 | Uimsbf |
| while( nextbits( )==’1’) { | | |
| extra_bit_slice /* with the value “1”*/ | 1 | Uimsbf |
| extra_information_slice | 8 | |
| } | | |
| } | | |
| extra_bit_slice /*with the value “0” */ | 1 | Uimsbf |
| do { | | |
| macroblock( ) | | |
| } while ( nextbits( ) != ‘000 0000 0000 0000 0000 | | |
| 0000’) | | |
| next_start_code( ) | | |
| } | | |

Through the above specific example of the MPEG standard, the way of including the matching information of the intra-coded MB into the video stream is illustrated. Of course, in the above embodiment, there are many alternative schemes, for example, the matching information of the intra-coded MB can be coded into the header segment of the picture or the header segment of the MB, or the extra information segment can be compensated with “0”. It should be noted that, for other video compression standards, e.g., H.263 or QuickTime, the syntax and the relevant requirements are different from those of MPEG, wherein the matching information of the intra-coded MB can be coded into different positions of the video stream depending on different standards.

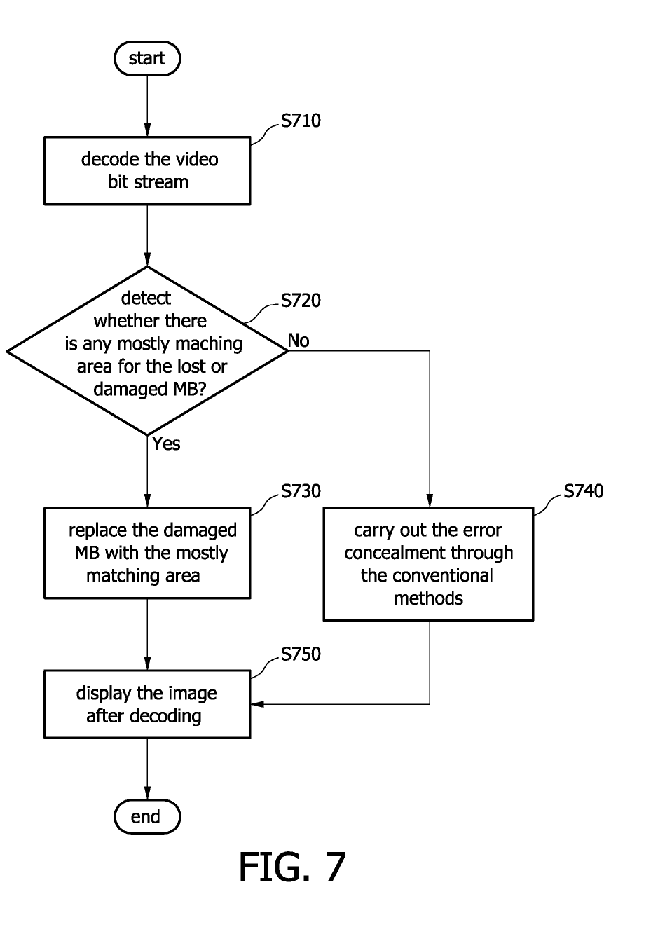

FIG. 7 is a flow chart for video decoding according to an embodiment of the present invention. According to the matching information of the intra-coded MB in the video stream, when the mostly matching area exists, the error concealment process is carried out by replacing the lost or damaged MB with a mostly matching area.

First, in step S710, the compressed video data is decoded according to the predetermined standard. After the compressed video stream has undergone variable length decoding (VLD), the matching information of the intra-coded MB is obtained for the lost or damaged MB. In step S720, it is determined from the obtained matching information of the intra-coded MB whether a matching area exists or not in the MB. If affirmative, e.g., the Matching_area_existing_flag is 1, the area is used to replace the lost or damaged MB in step S730.

If the MB is divided into many sub-units, the mostly matching area of each sub-unit is used to replace the corresponding sub-unit of the lost or damaged MB respectively. Otherwise, if the mostly matching area corresponding to the lost intra-coded MB does not exist, e.g., the Matching_area_existing_flag is 0, in step S740, error concealment is carried out to the lost intra-coded MB with the conventional method, such as, the prediction mode, interpolating, or copying with the periphery pictures of the lost MB, to form a new decoding picture. And then, the video picture is displayed in step S750. Finally, the decoding process of the picture is finished.

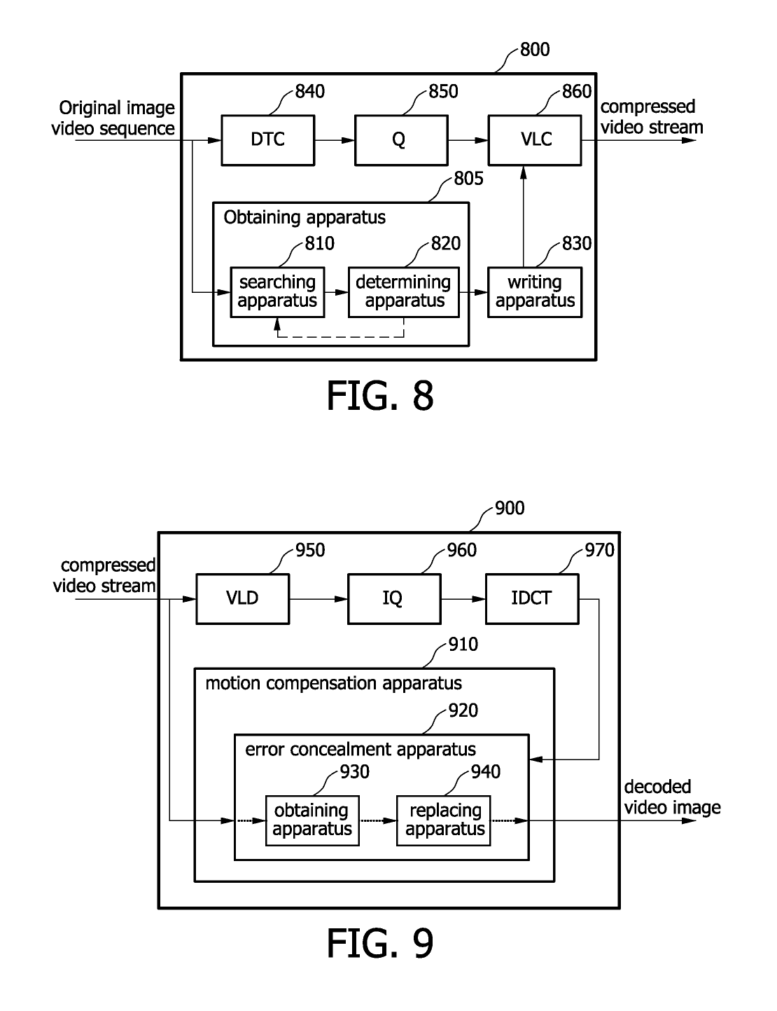

FIG. 8 is a schematic view of a coding apparatus according to an embodiment of the present invention. The coding apparatus 800 comprises an obtaining apparatus 805 and a writing apparatus 830, wherein the obtaining apparatus 805 comprises a searching apparatus 810, as shown by the solid line in the figure. The searching apparatus 810 is used for searching the mostly matching area for each sub-unit of each MB to be coded in the current picture under the specific mode. The writing apparatus 830 is used to write the mostly matching area information into the bit stream.

According to an embodiment with the MPEG coding of the present invention, wherein the coding method of the present invention is only applied to the intra-coded MB. The writing apparatus 830 is used to sequentially code the information indicating whether the intra-coded MB exists or not, the position information of the intra-coded MB, the information indicating whether the mostly matching area exists or not, the division mode information, and the position information of the mostly matching area into the slice header segment of the slice, to complete the coding of the picture. Particularly, the motion vector information including the horizontal and vertical vectors is employed to indicate the position of the mostly matching area.

According to an embodiment of the present invention, the obtaining apparatus 805 further comprises a determining apparatus 820. The determining apparatus 820 is used to determine whether or not the difference between the mostly matching area obtained by the searching apparatus 810 and the sub-unit of the corresponding MB to be coded satisfies the condition of the threshold value, i.e., less than or equal to the threshold value. If the above condition is satisfied, the information of the corresponding mostly matching area is transferred to the writing apparatus 830.

According to an embodiment of the present invention, in the searching apparatus 810, many division modes are predetermined. If the searching process with a specific mode has been finished, the searching apparatus 810 continues to search with other unexecuted predetermined division modes, until all the division modes are executed. The searching apparatus 810 compares the searching results of the individual division modes, and transfers the information of the mostly matching area with the smallest difference from the MB to be coded among all of the division modes into the determining apparatus 820.

If the determining apparatus 820 determines that the mostly matching area information satisfies the threshold value condition, the information of the mostly matching area is transferred into the writing apparatus 830. Otherwise, the writing apparatus 830 is informed that there is no matching area satisfying the threshold value condition. The writing apparatus 830 codes the information that there is no matching area satisfying the threshold value condition into the information segment, thereby finishing the coding of the picture.

According to another embodiment of the present invention, in the searching apparatus 810, many division modes are predetermined. If the searching process under a specific mode has finished, the searching apparatus 810 transfers the obtained information of the mostly matching area into the determining apparatus 820. If the determining apparatus 820 determines that the information of the mostly matching area satisfies the threshold value condition, the information of the mostly matching area is transferred into the writing apparatus 830. If the threshold value condition is not satisfied, it turns back to the searching apparatus 810 to continue searching with other unexecuted predetermined division modes (as shown by the dashed lines in the figure), until all of the division modes have been executed.

If after all the division modes have been executed, there is still no matching area satisfying the threshold value condition, the writing apparatus 830 is informed that there is no matching area satisfying the threshold value condition. The writing apparatus 830 codes the information that there is no matching area satisfying the threshold value condition into the information segment, thereby finishing the coding of the picture. The detailed description of the above coding process can be obtained with reference to the above description of the coding method.

The coding apparatus 800 further comprises a Discrete Cosine Transform (DCT) apparatus 840, a quantizer (Q) 850, and a variable length coding (VLC) apparatus 860, wherein the DCT apparatus 840 is used to receive the original sequence of the video picture, for performing a discrete cosine transformation.

As for the obtained DCT coefficient, the quantizer 850 is used to set different quantization levels according to different requirements, so as to reduce the bit rate. However, after the quantization, especially after setting different quantization levels for the low frequency component and high frequency component according to the physiologic characteristics of human eyes, the coefficient for most of the high frequency components will become 0. Generally, the human eyes are more sensitive to the low frequency component, and less sensitive to the high frequency component. Therefore, the quantization is more precise for the low frequency component, and less precise for the high frequency component.

The VLC apparatus 860 converts the quantization coefficient from the quantizer into a variable length code, e.g., Huffman code, according to the quantization range provided by the quantizer 850, such that the bit rate can be reduced. Meanwhile, the writing apparatus 830 writes the matching information into the compressed video stream. It is understood by those skilled in the art that the writing apparatus 830 is also included in the VLC apparatus 860.

FIG. 9 is a schematic view of the structure of a decoding apparatus according to an embodiment of the present invention. The decoding apparatus 900 comprises a motion compensation apparatus 910, for reducing the temporal redundancy by utilizing the relativity between frames. Since motion compensation is not the feature of the present invention, the details about motion compensation will not be described herein in detail.

The motion compensation apparatus 910 comprises an error concealment apparatus 920, which is used to determine whether or not there are mostly matching areas for the lost or damaged MB in the current picture for replacing the MB. If so, replace the MB with the mostly matching area, thereby finishing the error concealment.

According to an embodiment of the present invention, the error concealment apparatus 920 may comprise an obtaining apparatus 930, for obtaining the matching information of a damaged MB in the video stream. The matching information is used to indicate whether there is a mostly matching area in the current picture to replace the damaged MB.

According to an embodiment of the present invention, the error concealment apparatus 920 further comprises a replacing apparatus 940, for replacing the lost or damaged MB. If there are mostly matching areas existing for replacing the damaged MB, all the mostly matching areas for the MB can be obtained through the division mode information and the position information of the matching areas in the bit stream. Then, the mostly matching areas are used to replace the lost or damaged MB, thereby finishing the error concealment. As for this part, it has been illustrated in detail above, and will not be described herein redundantly. According to an embodiment of the present invention, if the mostly matching areas do not exist, it can be processed through other conventional common error concealment methods.

The decoding apparatus 900 further comprises a variable length decoding apparatus (VLD) 950, an inversed quantizer (IQ) 960, and an inversed discrete cosine transform apparatus (IDVT) 970. The decoding functions correspond to those of the VLC apparatus 860, the quantizer 850, and the DCT apparatus 840 of the coding apparatus 800 in FIG. 8, and will not be described in detail.

Although the technical contents and features of the present invention have been illustrated above, variations and modifications of the present invention without departing from the teachings and disclosure of the present invention can be made by those skilled in the art. Therefore, the protective scope of the present invention is not limited to the disclosure of the embodiments, but includes the variations and modifications without departing from the present invention, which is contemplated by the following claims.

1. A coding method for improving video error concealment, comprising:
(a) obtaining the relevant information of a mostly matching area for an area, wherein both the mostly matching area and the area are located in the same picture; and
(b) coding the relevant information of the mostly matching area into a coded video stream comprising the area.

2. The method according to claim 1, wherein the area is a macroblock (MB).

3. The method according to claim 1, wherein the area is a sub-unit of an MB, and the relevant information of the mostly matching area comprises the characteristic information of the sub-unit.

4. The method according to claim 1, wherein the area is an intra-coded area.

5. The method according to claim 1, wherein the step (a) further comprises:
searching the mostly matching area for the area within a specific range of the picture;
determining whether or not the difference between the mostly matching area and the area is less than a threshold value;
wherein, step (b) comprises coding the relevant information of the mostly matching area into the coded video stream comprising the area if the determining result is affirmative.

6. A decoding method for improving video error concealment, comprising:
(a) obtaining the matching information of a damaged MB in a picture, wherein the matching information indicates at least one matching area in the picture; and
(b) replacing the damaged MB with the at least one matching area according to the matching information.

7. The method according to claim 6, wherein the damaged MB is an intra-coded MB.

8. The method according to claim 6, wherein one of the at least one matching areas corresponds to one sub-unit of the damaged MB.

9. A coding apparatus for improving video error concealment, comprising:
an obtaining apparatus, for obtaining the relevant information of a mostly matching area for an area, the mostly matching area and the area being located in the same picture; and
a writing apparatus, for coding the relevant information of the mostly matching area into a coded video stream comprising the area.

10. The apparatus according to claim 9, wherein the area is an MB.

11. The apparatus according to claim 9, wherein the area is a sub-unit of an MB, and the relevant information of the mostly matching area comprises the characteristic information of the sub-unit.

12. The apparatus according to claim 9, wherein the area is an intra-coded area.

13. The apparatus according to claim 9, wherein the obtaining apparatus further comprises:
a searching apparatus, for searching the mostly matching area for the area within a specific range of the picture; and
a determining apparatus, for determining whether or not the difference between the mostly matching area and the area is less than a threshold value;
wherein, the writing apparatus codes the relevant information of the mostly matching area into a coded video stream comprising the area if the determined result is affirmative.

14. A decoding apparatus for improving video error concealment, comprising:
an obtaining apparatus, for obtaining the matching information of a damaged MB in a picture, wherein the matching information indicates at least one matching area within the picture; and
a replacing apparatus, for replacing the damaged MB with the at least one matching area according to the matching information.

15. The apparatus according to claim 14, wherein the obtaining apparatus obtains the motion vector information of the at least one matching area.

16. The method according to claim 14, wherein the damaged MB is an intra-coded MB.

17. The method according to claim 14, wherein one of the at least one matching areas corresponds to one sub-unit of the damaged MB.
